(19) United States
(12) Patent Application Publication
(10) Pub. No.: US 2026/0202380 A1
(43) Pub. Date: Jul. 16, 2026

(54) MODULAR EDDY CURRENT ARRAY (ECA) PROBE

(71) Applicant: EVIDENT CANADA, INC., Québec (CA)

(72) Inventors: François Brunet, Québec (CA); Dominique Nogues, Québec (CA); Benoit Lepage, L'Ancienne-Lorette (CA); Rémi Leclerc, Quebec City (CA)

(21) Appl. No.: 19/137,540

(22) PCT Filed: Dec. 22, 2023
(86) PCT No.: PCT/CA2023/051743

§ 371 Date: Jun. 10, 2025

Related U.S. Application Data
(60) Provisional application No. 63/477,651, filed on Dec. 29, 2022.

(51) Int. Cl. G01N 27/904; G01N 27/90

(52) U.S. Cl. CPC G01N 27/904; G01N 27/9006

(57) ABSTRACT

Various approaches can be used for performing eddy current inspection of a structure. Probe assembly configurations described herein can include a modular architecture, such as including an interface board, one or more multiplexer assemblies, and one or more sensor (e.g., coil element array) assemblies. Use of a modular approach facilitates rapid prototyping, fabrication, debug, or repair (or combinations thereof) because a respective interface board or multiplexer (or both) can be commonly shared across multiple probe assembly configurations. The sensor assembly can be modified, or a new sensor assembly mechanical configuration can be used, such as re-using an existing multiplexer and interface board configuration.

### CLAIM OF PRIORITY

This patent application claims the benefit of priority U.S. Provisional Patent Application Ser. No. 63/477,651, titled “MODULAR EDDY CURRENT ARRAY (ECA) PROBE,” filed on Dec. 29, 2022, which is hereby incorporated by reference herein in its entirety.

### TECHNICAL FIELD

This document pertains generally, but not by way of limitation, to apparatus and techniques for non-destructive inspection such as facilitating eddy current inspection, and more particularly, to apparatus and techniques for providing an Eddy Current Array (ECA) probe assembly having a modular architecture.

### BACKGROUND

Non-destructive testing (NDT) can refer to use of one or more different techniques to inspect regions on or within an object, such as to ascertain whether flaws or defects exist, or to otherwise characterize the object being inspected. One class of non-destructive testing can include use of an eddy current testing approach where electromagnetic energy is applied to the object and resulting induced currents on or within the object are detected, with the values of a detected current (or a related impedance) providing an indication of the structure of the object under test, such as to indicate a presence of a crack, void, porosity, or other inhomogeneity. Generally, an eddy current (EC) sensor includes one or more sensor elements such as inductive coils that can be excited using an alternating current (AC) source. Such coils (or other electromagnetic sensing elements such as hall sensors) can be used for receiving a signal indicative of an induced eddy current on or within the structure.

### SUMMARY

Examples described herein relate to a modular eddy current array (ECA) probe including an interface board configured to communicate with an acquisition instrument, wherein the interface board is provided on a first printed circuit board (PCB); a multiplexer board configured to be selectively coupled and decoupled to the interface board, wherein the multiplexer board is provided on a second PCB; and a coil assembly configured to be selectively coupled and decoupled to the multiplexer board.

Examples described herein relate to a method including: receiving, by an interface board of a modular ECA probe, a configuration command from an acquisition unit; saving, by a first multiplexer board of the modular ECA probe, configuration information for a first set of coil elements coupled to the first multiplexer board based on the configuration command; saving, by a second multiplexer board of the modular ECA probe, configuration information for a second set of coil elements coupled to the second multiplexer board based on the configuration command; performing inspection of an object by the modular ECA probe based on the saved configuration information by the first multiplexer board and the second multiplexer board.

Examples described herein relate to an inspection system including an interface board configured to be selectively coupled and decoupled to a plurality of different types of multiplexer boards; a first multiplexer board coupled to the interface board, wherein the first multiplexer board is configured to be selectively coupled and decoupled to a plurality of different types of coil assemblies; and a first coil assembly coupled to the first multiplexer board.

### BRIEF DESCRIPTION OF THE DRAWINGS

The subject matter herein may be better understood by referring to the following description in conjunction with the accompanying drawings. The drawings are not meant to limit the scope of the claims included herewith. For clarity, not every element may be labeled in every figure. The drawings are not necessarily to scale, emphasis instead being placed upon illustrating examples, principles, and concepts. Thus, features and advantages of the present disclosure will become more apparent from the following detailed description of examples thereof taken in conjunction with the accompanying drawings in which:

FIG. 1 shows example portions of a modular ECA probe;

FIG. 2 shows a simplified block diagram of the different modular configurations;

FIG. 3 shows example portions of a modular ECA probe with a plurality of daisy chained multiplexer boards;

FIG. 4 is a flow diagram of a method for configuring a modular ECA probe; and

FIG. 5 shows an example inspection sequence.

### DETAILED DESCRIPTION

Techniques for providing various probe configurations that can be used for performing eddy current (EC) testing are described. The probe configurations can be provided using modular architecture, such as including an interface board, one or more multiplexer (MUX) assemblies, and one or more sensor (e.g., coil element array) assemblies. Use of a modular approach facilitates rapid prototyping, fabrication, debug, or repair (or combinations thereof) because a respective interface board assembly or multiplexer (or both) can be commonly shared across multiple probe assembly configurations. The sensor assembly can be modified, or a new sensor assembly mechanical configuration can be used, such as re-using an existing multiplexer and interface board configuration.

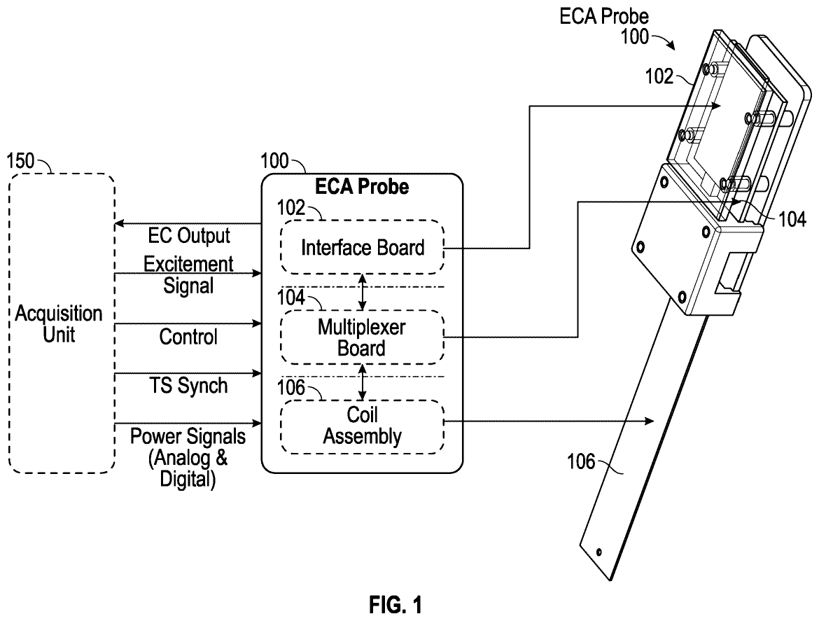

FIG. 1 shows example portions of a modular ECA probe 100. The modular ECA probe 100 includes an interface board 102, one or more multiplexer boards (shown as a multiplexer board 104), and one or more coil assemblies (shown as a coil assembly 106). FIG. 1 shows a simplified block diagram and an example of a physical embodiment of the modular ECA probe 100.

The interface board 102 can be coupled to an acquisition unit/instrument 150. The acquisition unit 150 can transmit control signals and power signals to the modular ECA probe 100 via the interface board 102. For example, the acquisition unit 150 can transmit an excitement signal to the modular ECA probe 100 to apply to the coil assembly 106. The acquisition unit 150 can also transmit control and configuration signals (e.g., through a RS-485 or like connection) and time slot (TS) synchronization signals. The acquisition unit 150 can also transmit analog and digital power signals to the modular ECA probe 100. The interface board 102 can transmit EC signals resulting from the inspection back to the acquisition unit 150. Example components included on the interface board are described in further detail below.

The interface board 102 is provided on a printed circuit board (PCB). The interface board 102 is selectively couplable and decouplable to the multiplexer board 104 and other multiplexer boards. Thus, the interface board 102 can be coupled to different types of multiplexer boards providing the modular configuration of the modular ECA probe 100. The multiplexer board 104 is provided on a separate PCB than the interface board 102. As described in further detail below, the interface board can be coupled to a plurality of multiplexer boards in a serial, daisy-chained manner in some examples. Example components included on the multiplexer board are described in further detail below.

The multiplexer board 104 is selectively couplable and decouplable to the coil assembly 106 and other coil assemblies. Thus, the multiplexer board 104 can be coupled to different types of coil assemblies providing the modular configuration of the modular ECA probe 100. The coil assembly 106 can include coils to generate the electromagnetic energy being applied to the testing object and to receive the induced EC signals.

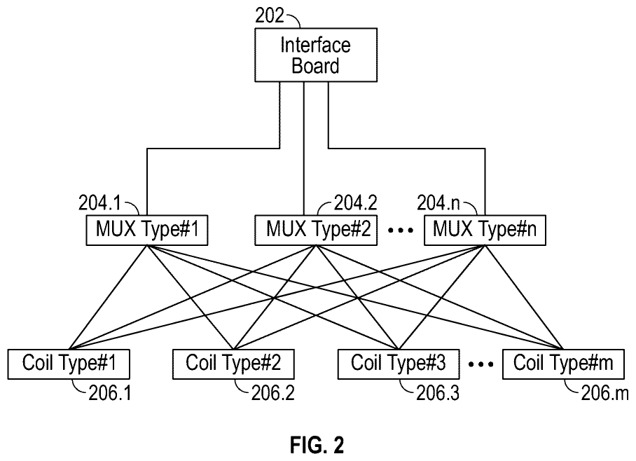

FIG. 2 shows a simplified block diagram of the different modular configurations. An interface board 202 can be selectively coupled to different types of multiplexer boards 204.1-204.n. The different types of multiplexer boards 204.1-204.n can provide different multiplexer configurations, such as absolute transmit/receive (T/R), absolute bridge, digital logical circuits, etc.

Respective multiplexer boards of multiplexer boards 204.1-204.n can be selectively coupled to different types of coil assemblies 206.1-206.m. The different types of coil assemblies 206.1-206.m can provide different coil element configurations, such as size, frequency, physical arrangements, flexible (e.g., PCB flex), wired coils, etc. The coil assemblies 206.1-206.m can be configured to detect different types of defects such as longitudinal and oblique defects.

Providing the interface boards, multiplexer boards, and coil assemblies as modular components can allow different ECA probe permutations. Consider an example of four different multiplexer boards and ten different coil assemblies. With the modular approach, as described herein, forty different probe assembly permutations can be provided. The modular EC probes, as described herein, can be adapted to different coil developments in much shorter time than developing entirely new probe configuration. For example, when a new coil assembly is introduced, it can be easily integrated in a modular probe with four new probe assembly permutations in the example above with four different multiplexer boards. And when a new multiplexer board is introduced, it can be easily integrated in a modular probe with ten new probe assembly permutations in the example above with ten different coil assemblies.

The modular elements can be assembled (and disassembled) easily. For example, the modular elements can be plugged together using connection devices, such as header pins or connectors. The modular assembly also is easier to troubleshoot production or field issues. The modular approach can allow a faulty to part to be more easily identified and replaced for repair or before probe final assembly.

“Intelligence” of the modular ECA probe can be provided in different locations. In some examples, the “intelligence” can be provided on the interface board by including a microcontroller in the interface board, making it a “smart” board. The microcontroller on the smart board can control inspection operations of the modular ECA probe.

In some examples, the “intelligence” can be provided on the multiplexer board by including a microcontroller in the multiplexer board. Incorporating a microcontroller in the multiplexer board can also allow using a plurality of multiplexer boards (and their corresponding attached coil assemblies) in a single modular ECA probe. The plurality of multiplexer boards can be connected in a serial, daisy-chain manner. That is, the interface board can be coupled to a first multiplexer board, which in turn can be connected to a second multiplexer board, and so on.

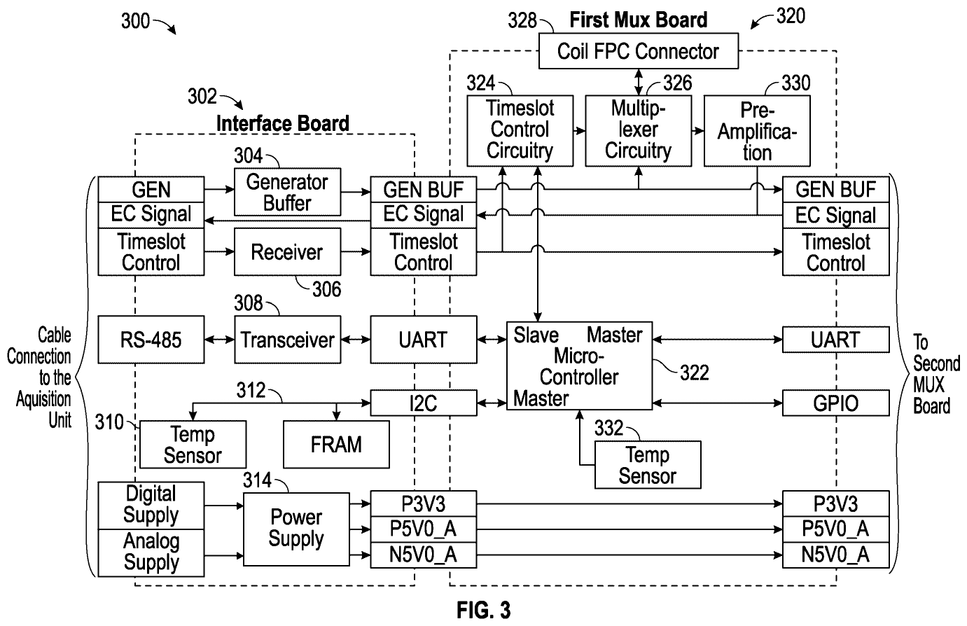

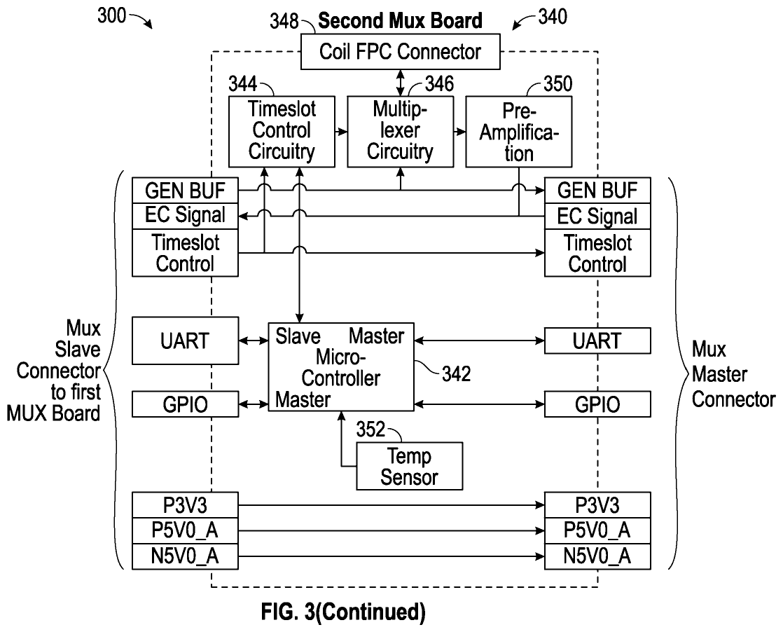

FIG. 3 shows example portions of a modular ECA probe 300 with a plurality of daisy chained multiplexer boards. The modular ECA probe 300 includes an interface board 302. The interface board 302 can include a cable connection to an acquisition unit (not shown) and a connection to a first multiplexer board 320. The interface board 302 can include a generation buffer 304 to receive the generation signal (e.g., excitement signal) from the acquisition unit. The generation buffer 304 can include an amplifier and other signal conditioning circuitry. The interface board 302 can include a receiver 306 to receive timeslot (TS) control signals from the acquisition unit. The TS control signals may provide sequence information for which coils to excite for transmission, and which coils to use for reception of the EC signal for respective timeslots.

The interface board 302 can include a transceiver 308 to communicate configuration and other control information to/from the acquisition unit and to/from the first multiplexer board 320. For example, the transceiver 308 can use a UART connection to the first multiplexer board 320.

The interface board 302 can include a temperature sensor 310. The temperature sensor 310 can monitor the temperature on the interface board 302 to ensure proper operating conditions. The interface board 302 can include a memory 312 (e.g., FRAM). The memory 312 can be coupled to the first multiplexer board 320, for example, using a I2C connection.

The interface board 302 can also include a power supply 314. The power supply 314 can receive power signals from the acquisition unit. The power signals may be analog and digital power signals. The power supply 314 can supply MUX power signals to the first multiplexer board 320. The MUX power signals can include analog power signals for powering analog circuits, such as amplifiers, and digital power signals for powering digital circuits, such as microcontrollers on the multiplexer boards.

The interface board 302 can be selectively coupled to the first multiplexer board 320 via a connector. The connector may include connections from the generation buffer 304 (GEN BUF), receiver 306 (TS control), transceiver 308 (UART), temperature sensor 310 and memory 312 (I2C), and power supply 314 (P3V3, P5V0_A, NSV0_A). The first multiplexer board 320 includes a microcontroller 322. The microcontroller 322 can control the operation of the first multiplexer board 320. For example, the microcontroller 322 can store configuration information of the modular ECA probe 300 in a local memory (e.g., RAM) and can control inspection operations based on the configuration information.

The first multiplexer board 320 includes TS control circuitry 324, which is coupled to a multiplexer circuitry 326. The TS control circuitry 324 can receive the TS control signal from the interface board 302 and may operate the multiplexer circuitry 326 accordingly. The multiplexer circuitry 326 may receive the generation signal from the generation buffer 304 and may route the generation signal to the appropriate coils via a coil connector 328 based on the TS information. The resulting EC signal may be received from the coil connector 328 and processed by a pre-amplification circuit 330. The pre-amplification circuit 330 may include an amplifier to amplify the EC signal and other signal conditioning circuits. The EC signal may then be routed to the interface board 302 and then to the acquisition unit. The first multiplexer board 320 may also include a temperature sensor 332.

The first multiplexer board 320 may be selectively coupled to a second multiplexer board 340 using a connector. In this configuration, the second multiplexer board 340 may operate as a slave to the first multiplexer board 320 (which operates as a master in this relationship). The second multiplexer board 340 includes a microcontroller 342. The microcontroller 342 can control the operation of the second multiplexer board 340. For example, the microcontroller 342 can store configuration information of the modular ECA probe 300 in a local memory (e.g., RAM) and can control inspection operations based on the configuration information.

The second multiplexer board 420 includes TS control circuitry 344, which is coupled to multiplexer circuitry 346. The TS control circuitry 344 can receive the TS control signal from the first multiplexer board 320 and may operate the multiplexer circuitry 346 accordingly. The multiplexer circuitry 346 may receive the generation signal from the generation buffer 304 via the first multiplexer board 320 and may route the generation signal to the appropriate coils via a coil connector 348 based on the TS information. The resulting EC signal may be received from the coil connector 348 and processed by a pre-amplification circuit 350. The pre-amplification circuit 350 may include an amplifier to amplify the EC signal and other signal conditioning circuits. The EC signal may then be routed to the first multiplexer board 32 and then the interface board 302 and then to the acquisition unit. The second multiplexer board 340 may also include a temperature sensor 352.

Additional multiplexer boards may be connected in this daisy-chain configuration. The use of daisy-chained multiplexer boards can allow the use of more coil configurations. For example, if each multiplexer board can accommodate 32 coils, then a two-board configuration can accommodate 64 coils, a three-board configuration can accommodate 96 coils and so on.

In some examples, subset of coils may be shared by different multiplexer boards. For example, a first multiplexer board can be connected to a set of 1-32 coils in a larger coil assembly. A second multiplexer board may be connected to a set of 30-62 coils from the same coil assembly, where coils 30-32 are shared by the first and second multiplexer boards.

Notably, from the perspective of the acquisition unit the modular ECA probe operates as a single unit, and the acquisition unit may not have information about the specific configuration of the multiplexer boards and their coil arrangement. Sensors are formed by the multiplexer boards through the interconnection of coil(s) as transmitter and coil(s) as receivers. In some examples, the acquisition unit may only have information about the number, nature and physical positioning of sensors produced by the modular MUX/Probe assembly without knowledge of the underlying coils multiplexing. The inner modular operations of the ECA probe may be unknown to the acquisition unit.

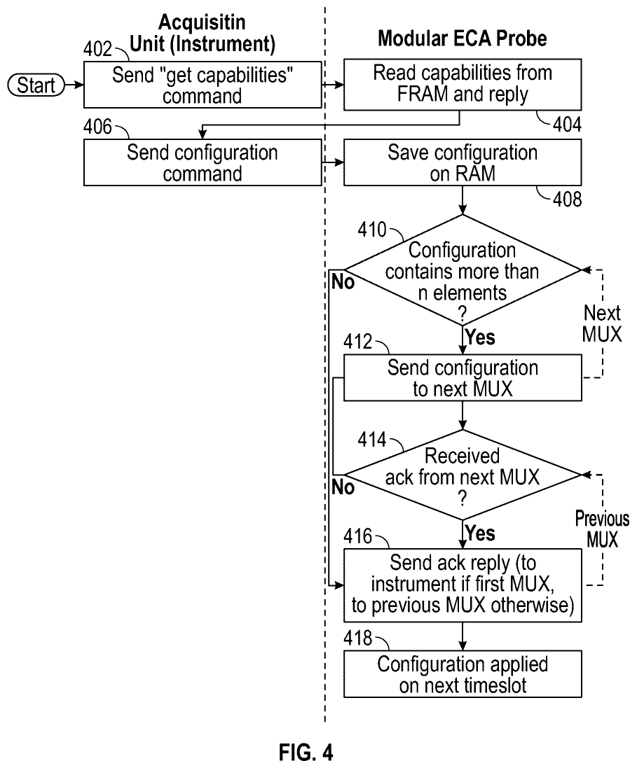

FIG. 4 is a flow diagram of a method 400 for configuring a modular ECA probe. At operation 402, an acquisition unit may transmit a “get capabilities” command to the probe. At operation 404, the probe may read probe capabilities stored in its memory (e.g., FRAM on interface board) and transmit a reply including the probe capabilities. In some examples, the probe capabilities may include information about the number, nature and physical positioning of sensors produced by the modular MUX/Probe assembly without knowledge of the underlying coils multiplexing. From the perspective of the acquisition unit, the probe can be seen as a single unitary structure.

At operation 406, the acquisition unit can transmit a configuration command to the probe. The configuration command include information about which sensors are going to be used for inspection and in which sequence. At operation 408, the configuration command may be routed to the first multiplexer board and the configuration information can be saved in the RAM associated the first microcontroller on the first multiplexer board. At operation 410, the first microcontroller on the first multiplexer board can check if the configuration command includes more than n elements, where n is the maximum number of coil elements connected to the first multiplexer board (e.g., 32 elements). If yes, at operation 412, the configuration command may be transmitted to the next (second) multiplexer board. The second multiplexer board and any additional multiplexer boards may then perform operations 408-410, until the configuration command information is stored in all respective multiplexer boards.

At operation 414, an acknowledgment may be received by the daisy-chained multiplexer boards, acknowledging that the configuration command has been stored. For example, a third multiplexer board can send an acknowledgement to the second multiplexer board after the third multiplexer board successfully saves the configuration command, and the second multiplexer board can send an acknowledgement to the first multiplexer board after the second multiplexer board successfully saves the configuration command. At operation 416, the first multiplexer board can send an acknowledgment reply to acquisition unit after the configuration command has been stored in the respective multiplexer boards. At operation 418, the probe can then apply the configuration in the next designated timeslot.

The modular ECA probe can be operated to use different coil configurations to perform different inspection techniques. For example, the modular ECA probe can be used to detect different types of defects, such as longitudinal and transverse defects.

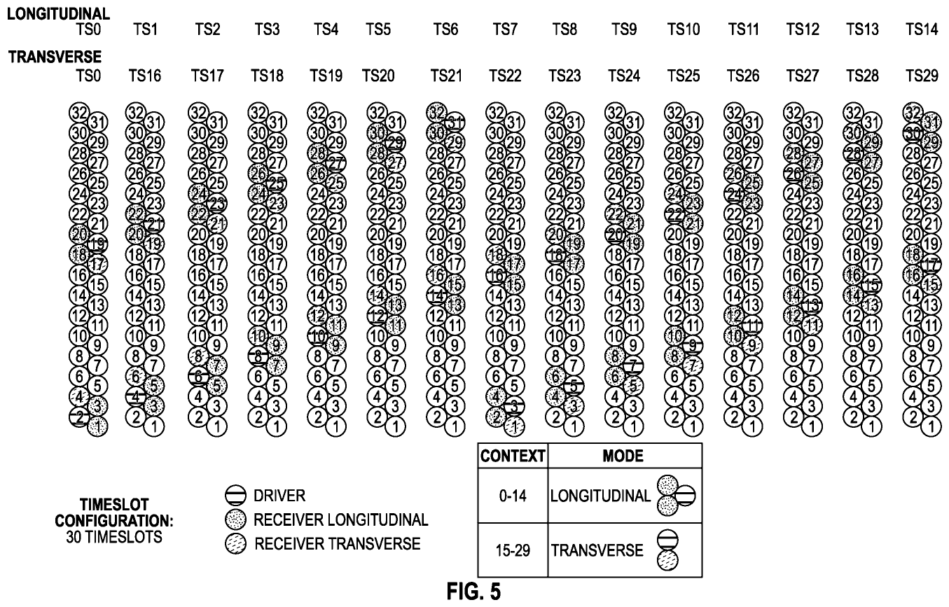

FIG. 5 shows an example inspection sequence. In this example, a first multiplexer board may be coupled to thirty-two coil elements. FIG. 5 shows the TS sequence for thirty timeslots (TS0-TS29). In this example, the first fifteen timeslots (TS0-TS14) are used to detect longitudinal defects and the second fifteen timeslots (TS15-TS20) are used to detect transverse defects. For example, at TS0 coils 2 and 19 may be driven for transmission and the EC signals may be received on coils 18 and 20 for driver coil 19 and coils 1 and 3 for driver coil 2. This configuration can be used for detecting longitudinal defects. For transverse defect detection, at TS15, for example, coils TS0 coils 2 and 19 may be driven for transmission and the EC signals may be received on coil 17 for driver coil 19 and coil 4 for driver coil 2.

More multiplexer boards with different coupled coil configurations can also be added. For example, TS30-59 may be handled by a second multiplexer board and its respective coupled coil elements, and TS60-89 may be handled by a third multiplexer board and its respected coil elements. In some examples, some coil elements may be shared by multiple multiplexer boards, as described above.

Moreover, the timeslots for the different multiplexer boards can be continuous, as described in the above example, or discontinuous. For example. TS1 can be handled by a first multiplexer board and its respective coil arrangement, TS2-TS5 can be handled by a second multiplexer board and its respective coil arrangement, and TS6 can be handled by the first multiplexer board. In some examples, a timeslot can also be handled by multiple multiplexer boards at the same time. For example, driving operations (e.g., driving one or more coils) can be handled by a first multiplexer board, and receiving operations (e.g., receiving on one or more coils) can be handled by a second multiplexer board. Various sequence patterns can be accommodated by the modular ECA probe.

Use of a modular approach, as described herein facilitates rapid prototyping, fabrication, debug, or repair (or combinations thereof) because respective components (e.g., interface board, multiplexer board) can be commonly shared across multiple probe assembly configurations. The sensor assembly can be modified, or a new sensor assembly mechanical configuration can be used, such as re-using an existing multiplexer and interface board configuration.

Processing (e.g., executing one or more of the methods described herein) may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information. The memory may include a machine readable medium on which is stored one or more sets of data structures or instructions (e.g., software) embodying or utilized by any one or more of the techniques or functions described herein.

In some embodiments, the system may be embodied by one or more programmable processors executing one or more computer programs to perform the functions of the system. In some other embodiments, all or part of the system may be implemented as special purpose logic circuitry (e.g., a field-programmable gate array (FPGA) and/or an application-specific integrated circuit (ASIC)). In some other embodiments, all or part of the system may be implemented using electronic hardware circuitry that include electronic devices such as, for example, at least one of a processor, a memory, a programmable logic device or a logic gate.

In one embodiment, the methods described herein are not limited to the specific examples described. In a further embodiment, rather, any of the method steps may be re-ordered, combined or removed, or performed in parallel or in serial, as necessary, to achieve the results set forth above.

In some embodiments, the system may be implemented, at least in part, via a computer program product, (e.g., in a non-transitory machine-readable storage medium such as, for example, a non-transitory computer-readable medium), for execution by, or to control the operation of, data processing apparatus (e.g., a programmable processor, a computer, or multiple computers)). In certain embodiments, each such program may be implemented in a high level procedural or object-oriented programming language to communicate with a computer system. In certain other embodiments, however, the programs may be implemented in assembly or machine language. In some embodiments, the language may be a compiled or an interpreted language and it may be deployed in any form, including as a stand-alone program or as a module, component, subroutine, or other unit suitable for use in a computing environment. In some other embodiments, a computer program may be deployed to be executed on one computer or on multiple computers at one site or distributed across multiple sites and interconnected by a communication network.

The methods and apparatus of this disclosure may take the form, at least partially, of program code (i.e., instructions) embodied in tangible non-transitory media, such as floppy diskettes, CD-ROMs, hard drives, random access or read only-memory, or any other machine-readable storage medium.

When the program code is loaded into and executed by a machine, such as the computer of FIG. 4, the machine becomes an apparatus for practicing examples of the present subject matter. When implemented on one or more general-purpose processors, the program code combines with such a processor to provide a unique apparatus that operates analogously to specific logic circuits. As such, a general purpose digital machine can be transformed into a special purpose digital machine. In some other embodiment, a non-transitory machine-readable medium may include but is not limited to a hard drive, compact disc, flash memory, non-volatile memory, volatile memory, magnetic diskette and so forth but does not include a transitory signal per se.

The term “machine readable medium” or “machine readable storage medium” may include any medium that is capable of storing, encoding, or carrying instructions for execution by a machine and that cause the machine to perform any one or more of the techniques of the present disclosure, or that is capable of storing, encoding or carrying data structures used by or associated with such instructions. Non-limiting machine-readable medium examples may include solid-state memories, and optical and magnetic media. Accordingly, machine-readable media are not transitory propagating signals. Specific examples of massed machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic or other phase-change or state-change memory circuits; magnetic disks, such as internal hard disks and removable disks; magneto-optical disks; and CD-ROM and DVD-ROM disks.

Although the foregoing examples have been described in some detail for purposes of clarity of understanding, it will be apparent that certain changes and modifications may be practiced within the scope of the appended claims. The scope of the invention is limited only by the claims and the invention encompasses numerous alternatives, modifications, and equivalents.

Numerous specific details are set forth in the above description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured. Accordingly, the above implementations are to be considered as illustrative and not restrictive, and the invention is not to be limited to the details given herein, but may be modified within the scope and equivalents of the appended claims.

Various embodiments of the present disclosure have been described with reference to the accompanying drawings. It may be appreciated that these example embodiments are provided only for enabling those skilled in the art to better understand and then further implement the present disclosure and not intended to limit the scope of the present disclosure in any manner. It should be noted that these drawings and description are only presented as examples of embodiments and, based on this description, alternative embodiments may be conceived that may have a structure and method disclosed as herein, and such alternative embodiments may be used without departing from the principle of the disclosure as claimed in the present disclosure.

It may be noted that the flowcharts and block diagrams in the figures may illustrate the apparatus, method, as well as architecture, functions and operations executable by a computer program product according to various embodiments of the present disclosure. In this regard, each block in the flowcharts or block diagrams may represent a module, a program segment, or a part of code, which may contain one or more executable instructions for performing specified logic functions. It should be further noted that, in some alternative implementations, functions indicated in blocks may occur in an order differing from the order as illustrated in the figures. For example, two blocks shown consecutively may be performed in parallel substantially or in an inverse order sometimes, which depends on the functions involved. It should be further noted that each block and a combination of blocks in the block diagrams or flowcharts may be implemented by a dedicated, hardware-based system for performing specified functions or operations or by a combination of dedicated hardware and computer instructions.

The terms “comprise(s),” “include(s)”, their derivatives, and like expressions used herein should be understood to be open (i.e., “comprising/including, but not limited to”). The term “based on” means “at least in part based on”, the term “one embodiment” means “at least one embodiment”, and the term “another embodiment” indicates “at least one further embodiment”. Relevant definitions of other terms have been provided.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other implementations can be used, such as by one of ordinary skill in the art upon reviewing the above description. The Abstract is provided to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed implementation. Thus, the following claims are hereby incorporated into the Detailed Description as examples or implementations, with each claim standing on its own as a separate implementation, and it is contemplated that such implementations can be combined with each other in various combinations or permutations. The scope of the invention should be determined with reference to the appended claims, along with the full scope of equivalents to which such claims are entitled

1. A modular eddy current array (ECA) probe, comprising:
an interface board configured to communicate with an acquisition instrument, wherein the interface board is provided on a first printed circuit board (PCB);
a multiplexer board configured to be selectively coupled and decoupled to the interface board, wherein the multiplexer board is provided on a second PCB; and
a coil assembly configured to be selectively coupled and decoupled to the multiplexer board.

2. The modular ECA probe of claim 1, wherein the first PCB is connected to the second PCB using a connector.

3. The modular ECA probe of claim 1, wherein the interface board includes a microcontroller.

4. The modular ECA probe of claim 1, wherein the multiplexer board includes a microcontroller.

5. The modular ECA probe of claim 4, wherein the multiplexer board is a first multiplexer board, the modular ECA probe further comprising:
a second multiplexer board configured to be selectively coupled and decoupled to the first multiplexer board, wherein the second multiplexer board is provided on a third PCB.

6. The modular ECA probe of claim 5, wherein the microcontroller is a first microcontroller, and wherein the second multiplexer board includes a second microcontroller.

7. The modular ECA probe of claim 6, wherein the first microcontroller operates as a master to the second microcontroller.

8. The modular ECA probe of claim 7, wherein the coil assembly is a first coil assembly, the modular ECA probe further comprising:
a second coil assembly configured to be selectively coupled and decoupled to the second multiplexer board.

9. The modular ECA probe of claim 8, wherein a subset of coils is shared by the first coil assembly and the second coil assembly.

10. The modular ECA probe of claim 9, wherein the first multiplexer board is configured to control inspection operation of the modular ECA probe for a first set of timeslots based on a configuration command received from the acquisition instrument via the interface board, and
wherein a second multiplexer board is configured to control inspection operation of the modular ECA probe for a second set of timeslots based on the configuration command received from the acquisition instrument via the interface board and the first multiplexer board.

11. The modular ECA probe of claim 10, wherein control of the inspection operations by the first multiplexer board and the second multiplexer board is unknown to the acquisition instrument.

12. The modular ECA probe of claim 3, wherein the first multiplexer board and the second multiplexer board are connected in a serial, daisy-chain configuration.

13. A method comprising:
receiving, by an interface board of a modular ECA probe, a configuration command from an acquisition unit;
saving, by a first multiplexer board of the modular ECA probe, configuration information for a first set of coil elements coupled to the first multiplexer board based on the configuration command;
saving, by a second multiplexer board of the modular ECA probe, configuration information for a second set of coil elements coupled to the second multiplexer board based on the configuration command;
performing inspection of an object by the modular ECA probe based on the saved configuration information by the first multiplexer board and the second multiplexer board.

14. The method of claim 13, wherein performing inspection of the object includes:
driving, by the first multiplexer board, at least one element in the first set of coil elements and receiving a first resulting eddy current (EC) signal from the first set of coil elements in a first time slot;
driving, by the second multiplexer board, at least one element in second set of coil elements and receiving a second resulting EC signal from the second set of coil elements in a second time slot.

15. The method of claim 13, wherein the interface board is provided on a first printed circuit board (PCB), wherein the first multiplexer board is provided on a second PCB, and wherein the second multiplexer board is provided on a third PCB.

16. The method of claim 13, wherein the first multiplexer board is connected to the second multiplexer board in a serial, daisy-chain configuration.

17. The method of claim 13, wherein the first set of coil elements and the second set of coil elements share a subset of coil elements.

18. An inspection system comprising:
an interface board configured to be selectively coupled and decoupled to a plurality of different types of multiplexer boards;
a first multiplexer board coupled to the interface board, wherein the first multiplexer board is configured to be selectively coupled and decoupled to a plurality of different types of coil assemblies; and
a first coil assembly coupled to the first multiplexer board.

19. The inspection system of claim 18, wherein the interface board includes a microcontroller.

20. The inspection system of claim 18, further comprising:
a second multiplexer board coupled to the first multiplexer board, wherein the first multiplexer board includes a first microcontroller and the second multiplexer board includes a second microcontroller; and
a second coil assembly coupled to the second multiplexer board.
